(19) United States
(12) Patent Application Publication
(10) Pub. No.: US 2023/0380021 A1
(43) Pub. Date: Nov. 23, 2023

(54) INDUCTION HEATING APPARATUS AND METHOD OF CONTROLLING THE SAME

(71) Applicant: SAMSUNG ELECTRONICS CO., LTD., Suwon-si (KR)

(72) Inventors: Hongjoo KANG, Suwon-si (KR); Byoungmo SUNG, Suwon-si (KR); Younghoon WOO, Suwon-si (KR); Jiwoong CHOI, Suwon-si (KR)

(21) Appl. No.: 18/122,785

(22) Filed: Mar. 17, 2023

Related U.S. Application Data
(63) Continuation of application No. PCT/KR2023/002455, filed on Feb. 21, 2023.

(30) Foreign Application Priority Data
May 18, 2022 (KR) 10-2022-0060873
Aug. 22, 2022 (KR) 10-2022-0105094

(51) Int. Cl. H05B 6/06; H05B 6/12; H05B 6/36

(52) U.S. Cl. CPC H05B 6/062; H05B 6/1209; H05B 6/362

(57) ABSTRACT

Provided is an induction heating apparatus including a working coil, a main power supply circuit configured to supply the working coil with a main power for heating, a coil driver operating as a container detection circuit configured to detect the container on the working coil or as a heating circuit configured to heat the container on the working coil, and at least one processor configured to control the coil driver.

### CROSS-REFERENCE TO RELATED APPLICATION(S)

This application is a bypass continuation application of International Application No. PCT/KR2023/002455, filed on Feb. 21, 2023, which claims priority to Korean Patent Application No. 10-2022-0105094, filed on Aug. 22, 2022, and Provisional application No. 10-2022-0060873, filed on May 18, 2022, in the Korean Intellectual Property Office, the disclosures of which are incorporated by reference herein in their entireties.

### BACKGROUND

### 1. Field

Disclosed embodiments relate to an induction heating apparatus for heating a container by an induction heating method, and a method of controlling the same.

### 2. Description of Related Art

An induction heating apparatus is a cooking appliance that heats a cooking container using an electromagnetic induction phenomenon. Such an induction heating apparatus is considered beneficial in stability, ease of use, and environmental protection compared to conventional gas ranges, and thus come in wide use recently.

An induction heating apparatus includes a plate on which a cooking container is placed and a coil provided below the plate. When a current is applied to the coil, a magnetic field is generated, inducing a secondary current in the cooking container placed on the plate, and heat is generated by resistances of the cooking container itself.

Since an induction heating apparatus have a cooking container itself as a heat source, a cooking container formed of a metal material, such as iron, stainless steel, or nickel, may be used for the induction heating apparatus.

### SUMMARY

In accordance with an aspect of the disclosure, an induction heating apparatus including: a working coil 240; a main power supply circuit 210 configured to supply the working coil with a main power for heating; a coil driver 230 operating as a container detection circuit (DtC) configured to detect the container on the working coil or a heating circuit (HC) configured to heat the container on the working coil; and at least one processor 320 configured to control the coil driver.

The coil driver may include: a direct current (DC) power supply circuit 237 configured to supply the working coil with auxiliary power for container detection; a resonance capacitor 233b connected to the working coil; and a container detection switch 234 connected to the working coil, configured to be periodically turned on and off.

The at least one processor 320 may be configured to, while the coil driver operates as a container detection circuit, identify whether a container is present on the working coil based on a resonance signal generated by periodic on/off of the container detection switch.

In accordance with an aspect of the disclosure, a method of controlling an induction heating apparatus is a method of controlling an induction heating apparatus including a working coil 240, a main power supply circuit configured to supply the working coil with main power for heating, and a coil driver 230 configured to apply a current to the working coil.

The method may include, in response to the induction heating apparatus being powered on, converting the coil driver to operate as a container detection circuit; identifying whether a container is present on the working coil using the container detection circuit; and in response to a heating command being input while the container is located on the working coil, converting the coil driver to operate as a heating circuit.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is an external view illustrating an induction heating apparatus according to an embodiment;

FIGS. 2 and 3 are diagrams for describing a principle of heating in an induction heating apparatus according to an embodiment;

FIG. 4 is a block diagram illustrating an operation of an induction heating apparatus according to an embodiment;

FIGS. 5 and 6 are circuit diagrams schematically illustrating a circuit configuration involved in heating of an induction heating apparatus according to an embodiment;

FIGS. 7 and 8 are graphs showing a resonance signal generated from a container detection circuit of an induction heating apparatus according to an embodiment;

FIGS. 9 and 10 are diagrams illustrating another example of a detector included in a container detection circuit, in an induction heating cooking apparatus according to an embodiment;

FIG. 11 is a circuit diagram schematically illustrating a circuit configuration for when two working coils are provided, in an induction heating apparatus according to an embodiment;

FIG. 12 is a flowchart showing a method of controlling an induction heating apparatus according to an embodiment;

FIG. 13 is a diagram illustrating a container detection circuit formed during execution of a method of controlling an induction heating apparatus according to an embodiment;

FIG. 14 is a diagram illustrating a signal applied to a container detection switch to detect a container during execution of a method of controlling an induction heating apparatus according to an embodiment;

FIG. 15 is a diagram illustrating a heating circuit formed during execution of a method of controlling an induction heating apparatus according to an embodiment;

FIG. 16 is a flowchart illustrating a case in which a plurality of working coils are provided, in a method of controlling an induction heating apparatus according to an embodiment;

FIG. 17 is a diagram illustrating a container detection circuit formed during execution of a method of controlling an induction heating apparatus according to an embodiment; and

FIGS. 18, 19, and 20 are diagrams illustrating a heating circuit formed during execution of a method of controlling an induction heating apparatus according to an embodiment.

### DETAILED DESCRIPTION

An induction heating apparatus 1 according to an embodiment may be configured to, before performing a heating operation, detect a container on a working coil using a container detection circuit powered by a direct current (DC) power source instead of a main power source used for heating. Accordingly, it is possible to prevent an increase in power consumption and generation of noise caused due to a high voltage/large current used to detect a container.

In addition, the induction heating apparatus 1 may be configured to, after a heating operation starts, perform container detection using a current supplied to the working coil for heating such that a coil driving circuit may be efficiently used.

The induction heating apparatus 1 according to the embodiment includes: a working coil 240; a main power supply circuit 210 for supplying the working coil 240 with main power for heating; a coil driver 230 configured to operate as a container detection circuit (DtC) for detecting a container on the working coil 240 or a heating circuit (HC) for heating a container on the working coil 240; and at least one processor 320 configured to control the coil driver 230.

The coil driver 230 may include a direct current (DC) power supply circuit 237 configured to supply the working coil 240 with auxiliary power for container detection; a resonance capacitor 233b-1 connected to the working coil 240; and a container detection switch 234 connected to the working coil, configured to be periodically turned on/off.

The at least one processor 320 may be configured to, while the coil driver 230 operates as a container detection circuit, identify whether a container is present on the working coil based on a resonance signal generated by on/off operation of the container detection switch 234.

The coil driver 230 may further include a changeover switch configured to convert the coil driver 230 to operate as one of the container detection circuit and the heating circuit.

The at least one processor 320 may, in order to operate the coil driver 230 as the container detection circuit, control the changeover switch such that one end of the working coil is connected to the container detection switch.

The at least one processor 320 may, in order to operate the coil driver 230 as the heating circuit, control the changeover switch such that one end of the working coil is connected to the main power supply circuit.

The coil driver 230 may include a first main switch 231a and a second main switch 231b.

The at least one processor 320 may, while the coil driver 230 operates as the container detection circuit, turn off both the first main switch 231a and the second main switch 231b.

The at least one processor 320 may, while the coil driver 230 operates as the heating circuit, alternately turn on/off the first main switch 231a and the second main switch 231b.

The induction heating apparatus may further include a current sensor 236 configured to detect a current flowing through the working coil 240.

The at least one processor 320 may, while the coil driver 230 operates as the heating circuit, identify whether a container is present on the working coil 240 based on an output of the current sensor 236.

The coil driver 230 may further include a detector 235 configured to detect a resonance signal generated by periodic on/off of the container detection switch 234.

The at least one processor 320 may identify whether a container is present on the working coil based on the output of the detector 235.

The detector 235 may include a comparator configured to output a voltage pulse corresponding to the resonance signal.

The at least one processor 320 may identify whether a container is present on the working coil 240 based on the output voltage pulse.

The detector 235 may include a current sensor configured to detect a current corresponding to the resonance signal.

The at least one processor 320 may identify whether a container is present on the working coil 240 based on the detected current.

The at least one processor 320 may, in response to the induction heating apparatus being powered on, control the changeover switch to operate the coil driver 230 as the container detection circuit.

The at least one processor 320 may, in response to a heating command being input while the container is located on the working coil 240, control the changeover switch to operate the coil driver 230 as the heating circuit.

A method of controlling an induction heating apparatus according to an embodiment is a method of controlling an induction heating apparatus including a working coil 240, a main power supply circuit 210 configured to supply the working coil 240 with main power for heating, and a coil driver 230 configured to apply a current to the working coil 240.

The method of controlling the induction heating apparatus may include: in response to the induction heating apparatus being powered on, converting the coil driver 230 to operate as a container detection circuit; identifying whether a container is present on the working coil 240 using the container detection circuit; and in response to a heating command being input while the container is located on the working coil 240, converting the coil driver 230 to operate as a heating circuit.

The coil driver 230 may include: a direct current (DC) power supply circuit configured to supply the working coil 240 with auxiliary power for container detection; a resonance capacitor 233b-1 connected to the working coil 240; and a container detection switch 234 connected to the working coil 240, configured to be periodically turned on and off.

The identifying of whether a container is present on the working coil 240 may include periodically turning on/off the container detection switch and identifying whether a container is present on the working coil 240 based on a resonance signal generated by the periodic on/off of the container detection switch 234.

The coil driver 230 may further include a changeover switch configured to covert the coil driver 230 to operate as one of the container detection circuit 234 and the heating circuit.

The converting of the coil driver 230 to operate as a container detection circuit 234 may include controlling the changeover switch such that one end of the working coil 240 is connected to the container detection switch.

The converting of the coil driver 230 to operate as a heating circuit may include controlling the changeover switch such that one end of the working coil is connected to the main power supply circuit.

The method of controlling the induction heating apparatus may further include applying an alternating current to the working coil 240 using the heating circuit.

The induction heating apparatus 1 may include a first main switch 231a and a second main switch 231b.

The identifying of whether a container is present on the working coil 240 may include turning off both the first main switch and the second main switch.

The applying of an alternating current to the working coil 240 may include alternately turning on/off the first main switch and the second main switch.

The coil driver 230 may further include a current sensor configured to detect a current flowing through the working coil 240.

The method of controlling an induction heating apparatus may further include identifying whether a container is present on the working coil 240 based on an output of the current sensor while the coil driver 230 operates as a heating circuit.

The method of controlling an induction heating apparatus may further include, upon identifying that there is no container located on the working coil 240 while the coil driver 230 operates as a heating circuit, turning off the first main switch and the second main switch.

Embodiments disclosed in the present specification and the components shown in the drawings are merely embodiments of the disclosed disclosure and various modifications capable of replacing the embodiments and drawings of the present specification may be formed at the time of filing the present application.

Further, terms used herein are used to illustrate the embodiments and are not intended to limit and/or to restrict the disclosed disclosure. As used herein, singular forms are intended to include plural forms as well, unless the context clearly indicates otherwise.

Terms “comprise,” “is provided with,” “have,” and the like are used herein to specify the presence of stated features, numerals, steps, operations, components, parts or combinations thereof but do not preclude the presence or addition of one or more other features, numerals, steps, operations, components, parts, or combinations thereof.

Further, terms such as “unit,” “portion,” “block,” “member,” “module” may refer to a unit of processing at least one function or operation. For example, these terms may refer to at least one process implemented by software, a hardware component such as a field-programmable gate array (FPGA)/an application-specific integrated circuit (ASIC), or a combination of software and hardware.

In addition, the ordinal numbers, such as “first ˜” and “second ˜” used in front of the components described in the specification are only used to distinguish the components from each other without having other meanings, such as the order of connection and use between the components, priority, etc.

A reference numeral attached in each of operations is used to identify each of the operations, and this reference numeral does not describe the order of the operations, and the operations may be performed differently from the described order unless clearly specified in the context.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, embodiments of an induction heating apparatus and a control method thereof according to an aspect will be described in detail with reference to the accompanying drawings.

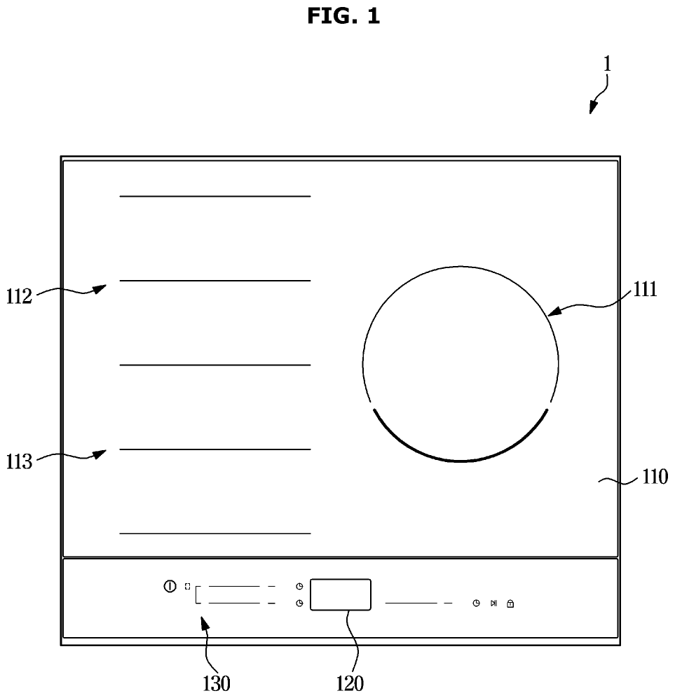

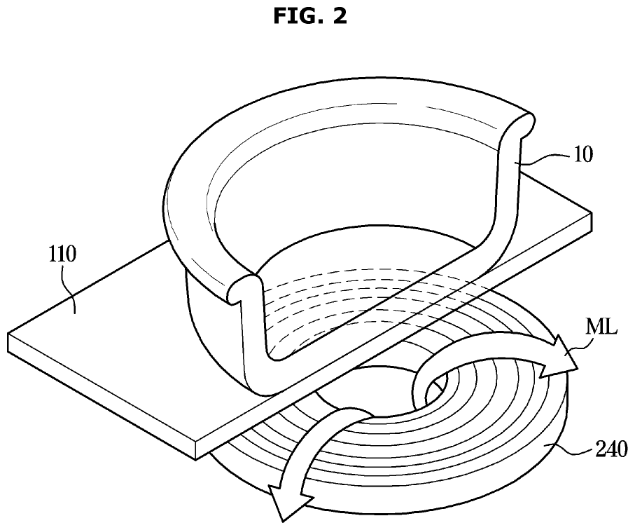

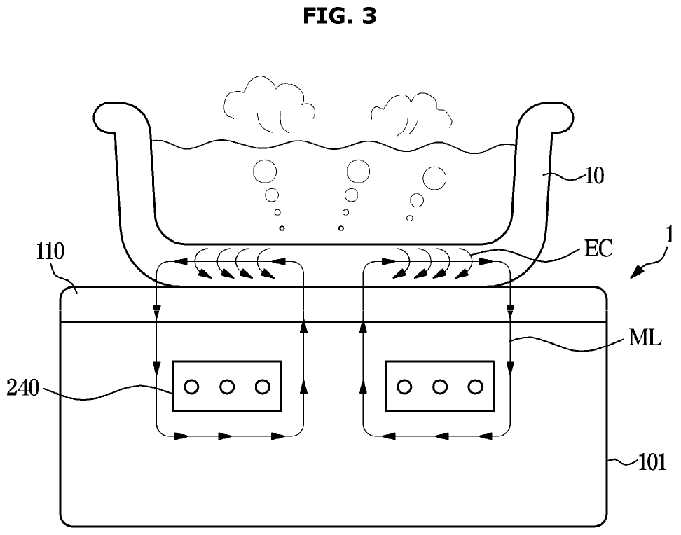

FIG. 1 is an external view illustrating an induction heating apparatus according to an embodiment, and FIGS. 2 and 3 are diagrams illustrating a principle of heating in an induction heating apparatus according to an embodiment.

In FIG. 1, a top view of an induction heating apparatus 1 according to an embodiment is illustrated. Referring to FIG. 1, the induction heating apparatus 1 according to the embodiment includes a plate 110 provided on an upper portion thereof, one or more cooking zones 111, 112, 113 formed on the plate 110, and one or more user interfaces 120, 130 serving as an input/output device. In some configurations, the plate 110 may be formed using ceramic although other materials may be employed without departing from the scope of the present disclosure.

The cooking zones 111, 112, 113 may represent positions in which cooking containers may be placed, and may be indicted in a circular shape (denoted as a reference numeral 111) or in a straight line (denoted as reference numerals 112 and 113) to guide proper arrangement of cooking containers on the cooking zones 111, 112, 113.

It will be appreciated that the above-described shapes are only examples of shapes for representing the cooking zones 111, 112, and 113, and not only circular or straight shape(s), but also various other shapes/geometries may be applied to embodiments of the induction heating apparatus 1. It will be appreciated that the selected shapes and geometries of the cooking zones (zones 111, 112, 113 or others) are designed to guide the user to the location of the respective cooking zone(s).

In addition, the present example is illustrated as having three cooking zones on the plate 110, but the embodiment of the induction heating apparatus 1 is not limited thereto. Only one or two cooking zones may be formed or defined on the plate 110, and also four or more cooking zones may be formed or defined on the plate 110. As such, the illustrative configuration is merely for explanatory and illustrative purposes and is not intended to be limiting.

In one area of the plate 110, a display 120 and an input device 130 may be provided. The display 120 may include a display device, such as a liquid crystal display (LCD) or a light emitting diode (LED), and the input device 130 may include at least one of various input devices, such as one or more of a touch pad, a button, a toggle, a switch, a dial, and a jog shuttle, or other type of input device. Alternatively, or in combination, the display 120 and the input portion 130 may be implemented as one or more touch screens.

In the example, a case in which the display 120 and the input device 130 are provided at positions spaced apart from the cooking zones 111, 112, 113 on the plate 110 is illustrated (i.e., on the top surface of the induction heating apparatus 1). However, the arrangement shown in FIG. 1 is only an example applicable to the induction heating apparatus 1, and the display 120 and/or the input device 130 may be placed at a position other than on the plate 110, such as the front of the heating cooking device 100.

Referring to FIGS. 2 and 3 together with FIG. 1, a working coil 240 used to heat a container 10 placed on the plate 110 may be disposed below the plate 110. Although only one working coil 240 is shown in FIGS. 2 and 3 for the sake of convenience of description, the working coil 240 may be provided corresponding in number to the number of cooking zones and/or multiple working coils may be provided for a given cooking zone.

When there are three cooking zones 111, 112, 113 as in the example of FIG. 1), the working coil 240 may also be provided as three working coils 240, and each of the working coils 240 may be placed at a lower side of a corresponding one of the cooking zones 111, 112, 113.

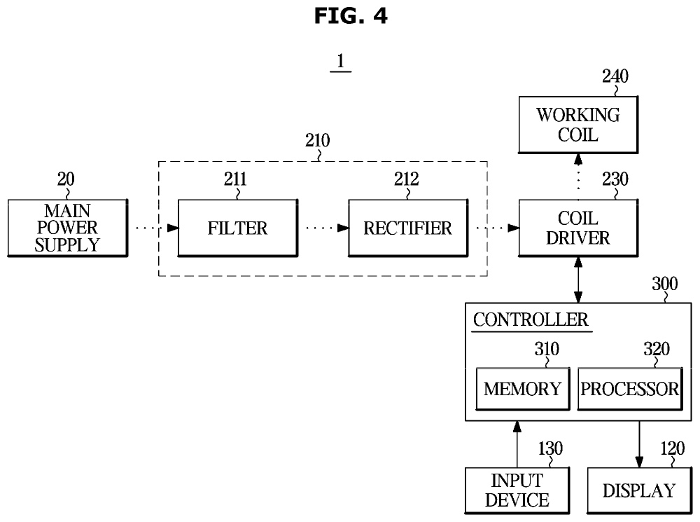

The working coil 240 may be connected to a coil driver 230 (see FIG. 4) to be described below, and may be supplied with a radio-frequency (RF) current from the coil driver 230. For example, the frequency of the RF current may be 20 kHz to 35 kHz.

When the working coil 240 has a RF current supplied thereto, lines of magnetic force ML may be formed in or about the working coil 240. When the container 10 having resistance is located within a range which the lines of magnetic force ML reach, the lines of magnetic force ML around the working coil 240 may pass through the bottom of the container 10, generating an induced current in the form of a vortex according to the law of electromagnetic induction, that is, eddy currents (EC).

The eddy current EC may interact with the electrical resistance of the container 10, generating heat in or on the container 10, and the generated heat may heat food inside the container 10.

In the induction heating apparatus 1, the container 10 itself acts as a heat source, and a metal having a resistance of a certain level or higher, such as iron, stainless steel, or nickel, may be used as a material of the container 10.

FIG. 4 is a block diagram illustrating an operation of an induction heating apparatus according to an embodiment.

Referring to FIG. 4, the induction heating apparatus 1 according to the embodiment includes a working coil 240, which has been described above, a main power supply circuit 210 for supplying the working coil 240 with power for heating the container 10, and a coil driver 230 configured to convert DC power delivered from the main power supply circuit 210 into high-frequency power and apply the converted high-frequency power to the working coil 240.

The main power supply circuit 210 may include a filter 211 configured to remove noise components included in the power supplied from a main power supply 20 and a rectifier 212 configured to convert AC power supplied from the main power supply 20 into DC power.

In addition, the induction heating apparatus 1 according to the embodiment may include a controller 300 configured to control the operation of the induction heating apparatus 1. The controller 300 may include at least one memory 310 in which a program for performing an operation described below is stored and at least one processor 320 configured to execute the stored program.

The at least one processor 320 may include a microprocessor. A microprocessor is a processing device in which an arithmetic logic operator, a register, a program counter, a command decoder, a control circuit, and the like are provided in at least one silicon chip.

The microprocessor may include a graphic processing unit (GPU) for graphic processing of images or videos. The microprocessor may be implemented in the form of a system on chip (SoC) including a core and a GPU. The microprocessor may include a single core, a dual core, a triple core, a quad core, and a core of multiples thereof.

In addition, the at least one processor 320 may include an input/output processor configured to mediate data access between various components included in the induction heating apparatus 1 and the controller 300.

The at least one memory 310 may include a non-volatile memory, such as a read only memory (ROM), a high-speed random access memory (RAM), a magnetic disk storage device, or a flash memory device, or other types of non-volatile semiconductor memory devices.

For example, the at least one memory 310 may be a semiconductor memory device, including at least one of a Secure Digital (SD) memory card, a Secure Digital High Capacity (SDHC) memory card, a mini SD memory card, a mini SDHC memory card, a Trans Flash (TF) memory card, a micro SD memory card, a micro SDHC memory card, a memory stick, a Compact Flash (CF), a Multi-Media Card (MMC), an MMC micro, or an eXtreme Digital (XD) card.

In addition, the at least one memory 310 may include a network attached storage device that allows an access through a network.

The controller 300 may control the induction heating apparatus 1 according to a user input received through the input device 130. For example, the input device 130 may receive a user input related to power on/off, selection of one or more of the cooking zones 111, 112, and 113, selection of a heating intensity of the selected cooking zone(s), setting of a timer, and the like.

For example, the controller 300 may select a working coil 240 to be supplied with high-frequency power according to a selection of a cooking zone received by the input device 130, and may adjust the intensity of a magnetic field generated by the working coil 240 according to a selection of the heating intensity received by the input device 130. In configurations having a single cooking zone, a heating intensity may be directly selected without selecting a cooking zone.

The display 120 may display information about the current state of the induction heating apparatus 1, information for guiding selection of one or more cooking zones and/or heating intensity, and information for guiding timer setting. In addition, as will be described below, the display 120 may display a notification indicating whether a container 10 is present.

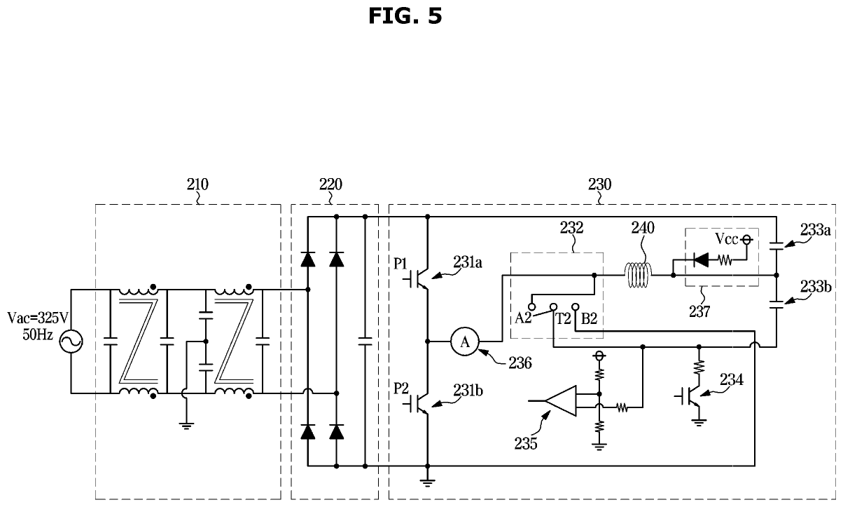

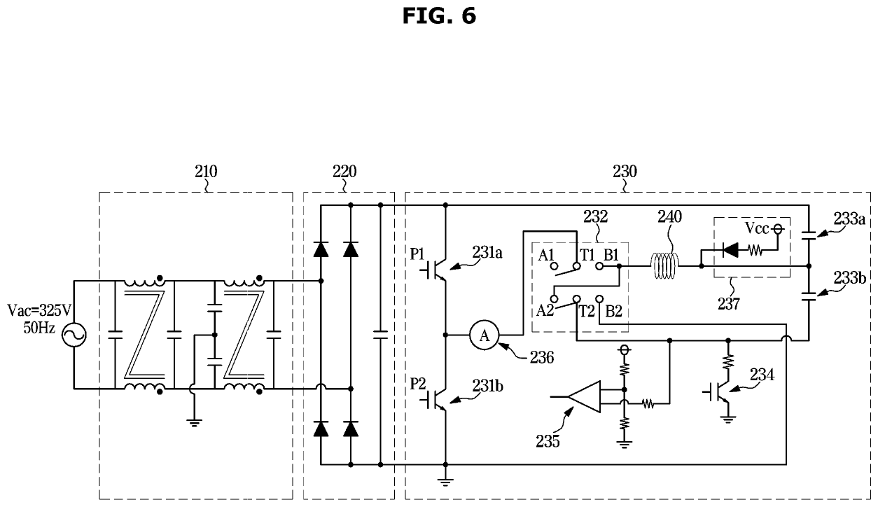

FIGS. 5 and 6 are circuit diagrams schematically illustrating a circuit configuration involved in heating of an induction heating apparatus according to an embodiment.

Referring to FIG. 5, the filter of the main power supply circuit 210 removes noise mixed in power supplied from the main power supply 20 that includes a transformer and a capacitor. The AC power that has passed through the filter is converted into DC power by the rectifier of the main power supply circuit 210.

The rectifier of the main power supply circuit 210 may include a bridge rectifier circuit including a plurality of diodes. For example, the bridge rectifier circuit may include four diodes. The diodes may form two pairs of diodes, each pair of diodes obtained by connecting diodes in series, and the two pairs of diodes may be connected in parallel with each other. The bridge diode may convert an AC voltage, of which the polarity changes over time, into a voltage, of which the polarity is constant, and convert an AC current, of which the direction changes over time, into a current, of which the direction is constant.

In addition, the rectifier of the main power supply circuit 210 may include a direct current (DC) link capacitor. The DC link capacitor may convert a voltage of which the magnitude changes over time into a DC voltage of a constant size. The DC link capacitor may maintain the converted DC voltage and provide the DC voltage to an inverter circuit, that is, the coil driver 230.

The coil driver 230 may include an inverter configured to convert the DC power, which is supplied from the main power supply circuit 210, back into AC power. For example, the coil driver 230 may include a half-bridge circuit including a pair of main switches 231a and 231b and a pair of resonance capacitors 233a and 233b. The pair of main switches 231a and 231b may be connected in parallel to the pair of resonance capacitors 233a and 233b.

The first main switch 231a and the second main switch 231b may switch the voltage applied to the working coil 240 such that AC current flows through the working coil 240. Although FIG. 5 illustrates the working coil 240 within the coil driver 230, such illustration is merely for illustrative purposes and simplicity of illustration, and the two components may be separate but electrically coupled. The working coil 240 has one end connected to a node between the first main switch 231a and the second main switch 231b connected in series with each other, and the other end connected to a node between the first resonance capacitor 233a and the second resonance capacitor 233a connected in series with each other.

The second resonance capacitor 233b may have one end connected to the other end of the working coil 240, and the other end connected to ground or the one end of the working coil 240 through the changeover switch 232.

The first main switch 231a and the second main switch 231b are turned on/off by switch driving signals P1 and P2. In this case, the switch driving signals P1 and P2 may be provided by the controller 300, and the controller 300 may alternately turn on/off the first main switch 231a and the second main switch 231b, thereby supplying the working coil 240 with a high-frequency alternating current.

The first main switch 231a and the second main switch 231b may be implemented as a three-terminal semiconductor device switch having a fast response speed so as to be turned on/off at high speed. For example, the first main switch 231a and the second main switch 231b may be provided as a bipolar junction transistor (BJT), a metal-oxide-semiconductor field effect transistor (MOSFET), an insulated gate bipolar transistor (IGBT) or a thyristor.

The pair of capacitors 233a and 233b may serve as a buffer. In addition, the resonant frequency of the working coil 240 may vary according to the capacitance of the capacitors 233a and 233b.

The frequency of a current applied to the working coil 240 determines the intensity of a magnetic field formed around the working coil 240, and an induced current is formed in the container 10 in proportion to the intensity of the magnetic field. Therefore, the amount of heat generated in the container 10 is determined in proportion to the frequency of the current applied to the working coil 240.

When the input device 130 receives a selection for the heating intensity from the user, the controller 300 may determine on/off frequencies of the first main switch 231a and the second main switch 231b based on the selected heating intensity. The controller 300 may alternately turn on/off the first main switch 231a and the second main switch 231b according to the determined on/off frequency, thereby applying, to the working coil 240, a high-frequency current having a frequency corresponding to the selected heating intensity.

On a current path between a contact point of the first main switch 231a and the second main switch 231b and the working coil 240, a current sensor 236 may be installed. The current sensor 236 may detect the magnitude of a current flowing through the working coil 240 or the magnitude of a driving current supplied to the working coil 240.

For example, the current sensor 236 may include a current transformer configured to proportionally reduce the magnitude of a driving current supplied to the working coil 240 and an ampere meter configured to detect the magnitude of the proportionally reduced current.

Information about the magnitude of the current detected by the current sensor 236 may be provided to the controller 300. The controller 300 may adjust the magnitude of a high-frequency current applied to the working coil 240 based on the information about the magnitude of the detected current.

In addition, the controller 300 may identify whether a container 10 is located on the working coil 240 based on the information about the magnitude of the detected current. For example, it may be identified that a container 10 is located on the working coil 240 in response to the magnitude of the detected current being lower than a reference value. Conversely, the controller 300 may identify that a container 10 is not located on the working coil 240 in response to the magnitude of the detected current being greater than or equal to the reference value.

The controller 300 may, upon identifying that a container 10 is not located on the working coil 240 while the high frequency current is being applied to the working coil 240, cut off the high frequency current applied to the working coil 240 so that the stability of the induction heating apparatus 1 may be improved.

The controller 300 may identify whether a container 10 is located on the working coil 240 before performing an operation of applying a high frequency current to the working coil 240, that is, before entering a heating mode, and upon identifying that a container 10 is not located on the working coil 240, prevent the high frequency current from being applied to the working coil 240. That is, a high-frequency current may be applied to the working coil 240 only when the container 10 is located on the working coil 240.

On the other hand, in a case in which a current is applied to the working coil 240 using the main power supply 20 to perform detection of a container 10 even before entering a heating mode, power consumption may increase and noise may occur during the container detection process.

The induction heating apparatus 1 according to the embodiment may detect the container 10 located on the working coil 240 using different methods between a heating mode in which a high-frequency current is applied to the working coil 240 and a container detection mode in which container detection is performed before entering the heating mode.

To this end, the coil driver 230 may be converted to operate as a heating circuit used to apply a high frequency current to the working coil 240 in a heating mode or as a container detection circuit used to detect a container 10 located on the working coil 240 in a container detection mode.

In other words, the coil driver 230 may operate as a heating circuit in a heating mode and operate as a container detection circuit in a container detection mode. The heating circuit and the container detection circuit may have components and paths that may, at least partly, overlap each other.

The coil driver 230 may include a DC power supply circuit 237 for applying auxiliary power required for container detection. The DC power supply circuit 237 may be connected to the other end of the working coil 240 to apply a current to the working coil 240 in a container detection mode.

The DC power supply circuit 237 may be connected on a path through which a current flows between the other end of the working coil 240 and a contact point between the two resonance capacitors 233a and 233b.

For example, the DC power supply circuit 237 may be supplied with a power voltage Vcc of 12V, 5V, or 3.3V, and may include a diode and a resistor.

The coil driver 230 may include a container detection switch 234 that is periodically turned on/off in a container detection mode to generate a resonance signal. The container detection switch 234 may be provided between the one end of the working coil 240 and the second resonance capacitor 233b. The container detection switch 234 may be connected to the one end of the working coil 240 by the changeover switch 232 in the container detection mode.

The coil driver 230 may include a detector 235 that detects a resonance signal generated by periodic on/off of the container detection switch 234. The detector 235 may be provided between the one end of the working coil 240 and the second resonance capacitor 233b.

The resonance signal detected by the detector 235 may be input to the controller 300. The controller 300 may detect the container 10 on the working coil 240 based on the resonance signal detected by the detector 235. Details thereof will be described below.

The DC power supply circuit 237, the container detection switch 234, the second resonance capacitor 233b, and the detector 235 may be included as components constituting the container detection circuit.

The coil driver 230 may include the changeover switch 232 that performs switching between the heating circuit and the container detection circuit. For example, the changeover switch 232 may be implemented as a double throw relay and may switch connection between a contact A2 and a contact B2.

When a terminal T2 of the changeover switch 232 is connected to the contact A2, a container detection circuit may be formed. When the terminal T2 of the changeover switch 232 is connected to the contact B2, a heating circuit may be formed.

Alternatively, as shown in FIG. 6, the changeover switch 232 may be implemented as a double pole double throw relay so as to switch connection between two contacts while switching connection between two other contacts (between a contact A1 and a contact B1/between a contact A2 and a contact B2).

When the terminals T1/T2 of the changeover switch 232 are connected to the contacts A1/A2, a container detection circuit may be formed. When the terminals T1/T2 of the changeover switch 232 are connected to the contacts B1/B2, a heating circuit may be formed.

The above-described examples of the changeover switch 232 are only examples that are applicable to the embodiment of the induction heating apparatus 1 illustrated, and the embodiment of the induction heating apparatus 1 is not limited thereto. The changeover switch 232 may be provided in various configurations or arrangements and is configured to switch the connection of one end of the working coil 240 to the node between the first main switch 231a and the second main switch 231b or the other end of the second resonance capacitor 233b. However, in the embodiment to be described below, a case in which the changeover switch 232 is implemented as a double pole double throw relay will be illustrated for detailed description.

When a container detection circuit is formed, the controller 300 may periodically turn on/off the container detection switch 234. When the container detection switch 234 is periodically turned on/off, resonance may be generated by the working coil 240 and the second resonance capacitor 233b, and the detector 235 may detect a resonance signal. The controller 300 may detect the container 10 on the working coil 240 based on the detected resonance signal.

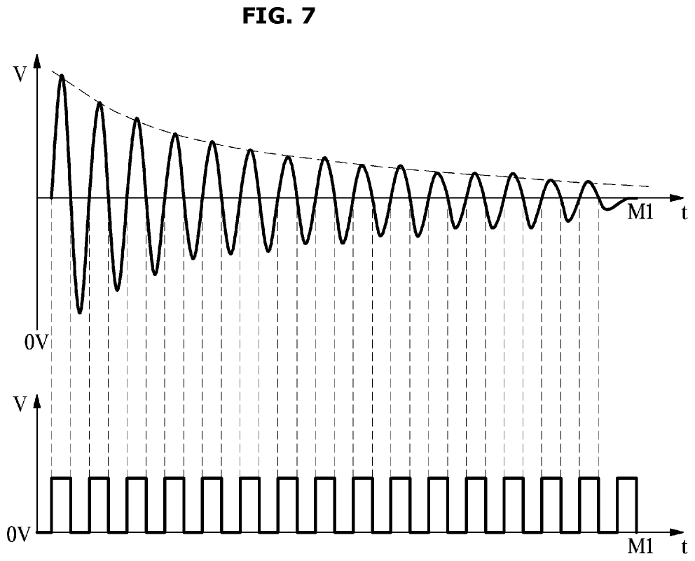

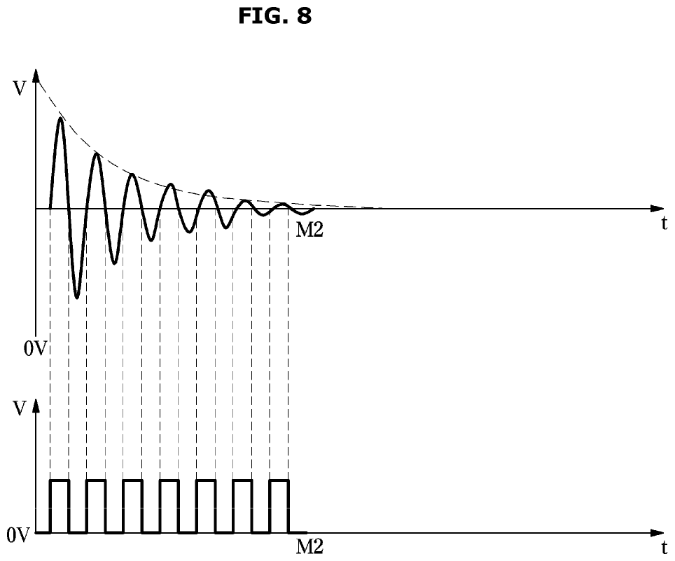

FIGS. 7 and 8 are graphs showing a resonance signal generated from a container detection circuit of an induction heating apparatus according to an embodiment.

Signals generated by the above-described resonance may be represented by voltage graphs shown in FIGS. 7 and 8. The resonance signal gradually attenuates and disappears over time. FIG. 7 illustrates attenuation of the signal over time t for a system when a container is not present, and FIG. 8 illustrates attenuation of the signal over time t for a system when a container is present. It is noted that in the graphs of FIGS. 7 and 8, the time duration t is the same, and thus a comparison of the graphs of the two may be performed. As shown in FIG. 7 and FIG. 8 compared to each other, it can be seen that when the container 10 is located on the working coil 240 (FIG. 8), the resonance signal attenuates and disappears faster than the resonance signal for when the container 10 is not present (FIG. 7).

As shown in FIG. 6, when the detector 235 includes a comparator implemented as an operational amplifier (OP Amp), pulse signals as shown in FIGS. 7 and 8 may be output from the detector 235. The pulse signals are shown in the lower plot or graph of each of FIGS. 7 and 8.

The output pulse signal is transmitted to the controller 300, and the controller 300 may count the pulses or count the duration of the pulses. The controller 300 may compare the counted number of pulses or the counted time with a reference value to identify whether the container 10 is present.

For example, the controller 300 may be configured to, in response to the counted number of pulses or the counted time being less than a reference value, identity that the container 10 is located on the working coil 240. For example, in FIG. 8, there are seven pulses, and attenuation happens rapidly. In comparison, in FIG. 7, there are sixteen pulses, and attenuation happens more slowly. That is, the time M1 in FIG. 7 is greater than the time M2 in FIG. 8.

In addition, the controller 300 may be configured to, in response to the counted number of pulses or the counted time being greater than or equal to the reference value, identify that the container 10 is not located on the working coil 240.

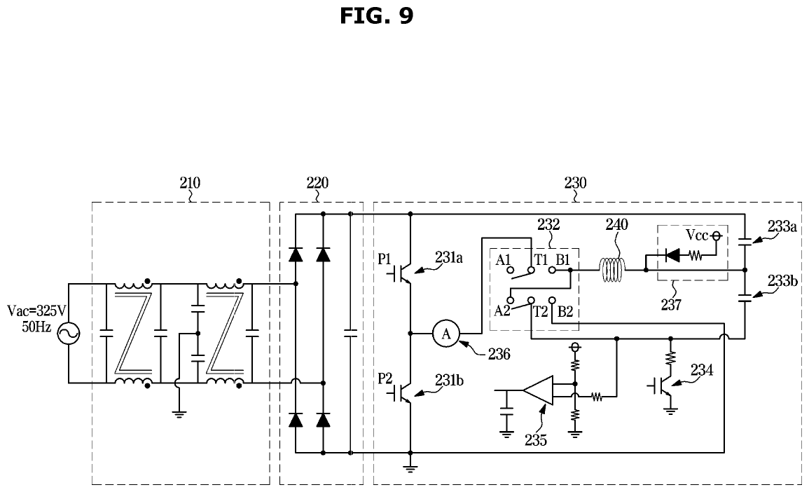

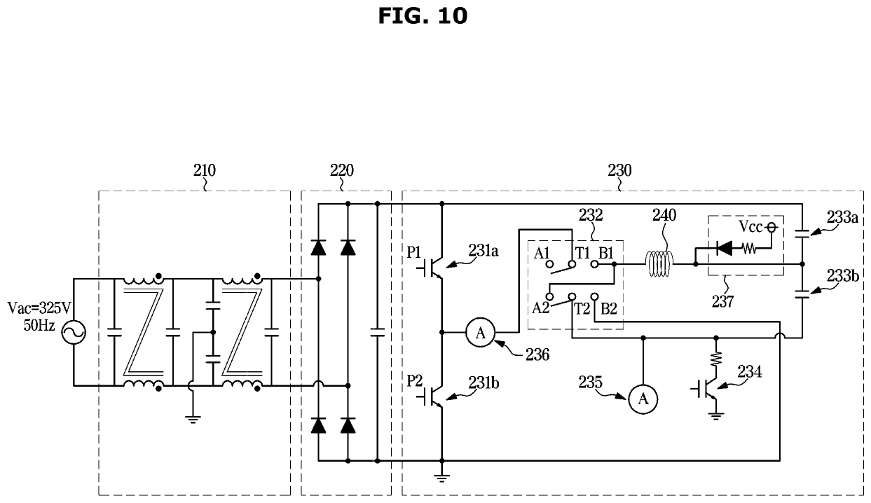

FIGS. 9 and 10 are diagrams illustrating another example of a detector included in a container detection circuit, in an induction heating cooking apparatus according to an embodiment. Although FIGS. 9 and 10 illustrate the working coil 240 within the coil driver 230, such illustration is merely for illustrative purposes and simplicity of illustration, and the two components may be separate but electrically coupled.

Referring to FIG. 9, the detector 235 included in the container detection circuit of the coil driver 230 may further include a capacitor connected to an output terminal of the comparator described above.

In this case, a voltage value may be input to the controller 300, and the controller 300 may detect the container 10 on the working coil 240 by comparing the input voltage value with a reference value. For example, the controller 300 may be configured to, in response to the input voltage value being less than the reference value, identify that the container 10 is located on the working coil 240. In addition, the controller 300 may be configured to, in response to the input voltage value being greater than or equal to the reference value, identify that the container 10 is not located on the working coil 240.

Referring to FIG. 10, the detector 235 included in the container detection circuit of the coil driver 230 may include a current sensor.

In this case, a current value may be input to the controller 300, and the controller 300 may detect the container 10 on the working coil 240 by comparing the input current value with a reference value. For example, the controller 300 may be configured to, in response to the input current value being less than the reference value, identify that the container 10 is located on the working coil 240. In addition, the controller 300 may be configured to, in response to the input current value being greater than or equal to the reference value, identify that the container 10 is not located on the working coil 240.

The configuration of the detector 235 described above is only an example applicable to the embodiment of the induction heating apparatus 1. In addition to the above examples, any configuration capable of detecting a resonance signal generated by the container detection circuit may be applied to the detector 235.

Meanwhile, when the terminals T1/T2 of the changeover switch 232 are connected to the contacts B1/B2, a heating circuit may be formed. In response to the heating circuit being formed, the first main switch 231a and the second main switch 231b may be alternately turned on/off to supply a high-frequency current to the working coil 240 as described above.

When the coil driver 230 operates as a heating circuit, the current sensor 236 connected to the contact point between the first main switch 231a and the second main switch 231b may detect the current flowing through the working coil 240.

The detected current value may be input to the controller 300, and the controller 300 may, based on the detected current value, perform not only the above-described output adjustment or current limitation, but also a container detection.

However, in a case in which the container detection is performed using high voltage and high current supplied from the main power source 20 even when a heating operation is not performed, power consumption may increase and noise may occur.

As described above, the induction heating apparatus 1 according to the embodiment may be configured to, before performing a heating operation, perform the container detection with low power using the container detection circuit, so that detection of the container 10 on the working coil 240 may be performed while minimizing an increase in the power consumption and generation of noise.

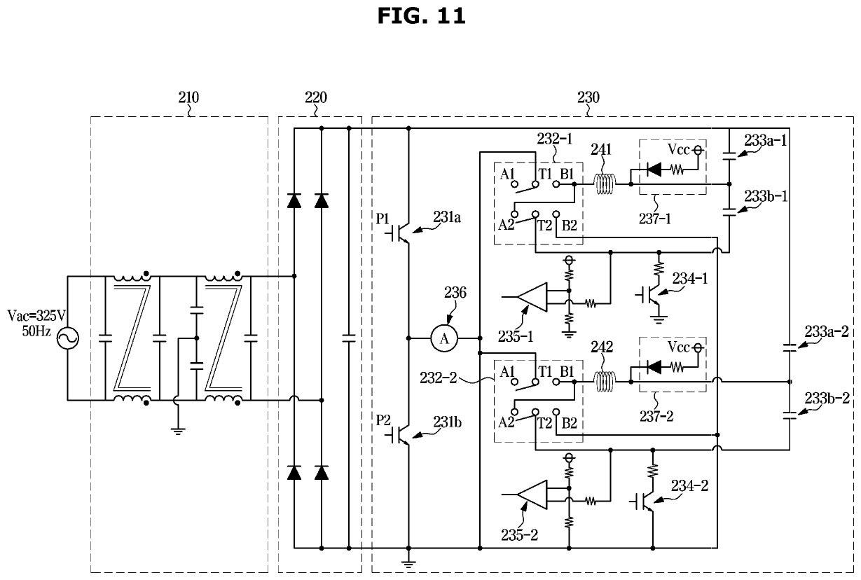

FIG. 11 is a circuit diagram illustrating a circuit configuration for a case in which two working coils are provided in an induction heating apparatus according to an embodiment.

The configuration of the main power supply circuit 210 for supplying main power for heating is the same as that described above with reference to FIGS. 5 and 6. In addition, descriptions of the same components having the same reference numerals as those of the above will be omitted as needed.

Referring to FIG. 11, when two working coils 241, 242 are provided, a heating circuit for heating the container 10 on the working coils 241, 242 and a container detection circuit for detecting the container 10 on the working coils 241, 242 may also be provided in two units thereof corresponding in number of the two working coils 241, 242. Although FIG. 11 illustrates the working coils 241, 242 within the coil driver 230, such illustration is merely for illustrative purposes and simplicity of illustration, and the two components may be separate but electrically coupled.

That is, the configuration of the heating circuit and the configuration of the container detection circuit of FIG. 6 described above may each be provided in two units thereof.

Specifically, a first changeover switch 232-1 and a second changeover switch 232-2 may be connected in parallel to a contact point of a first main switch 231a and a second main switch 231b.

The first changeover switch 232-1 may be disposed between the contact point of the first main switch 231a and the second main switch 231b and a first working coil 241. For example, the first changeover switch 232-1 may be implemented as a double pole double throw relay so as to switch connection between two contacts while switching connection between other two contacts (between a contact A1 and a contact B1/between a contact A2 and a contact B2).

The first working coil 241 may have one end connected to the first changeover switch 232-1 and the other end connected to a contact point between a pair of resonance capacitors 233a-1 and 233b-1 connected in series. A first DC power supply circuit 237-1 may be connected on a path through which current flows between the contact point and the other end of the first working coil 241.

A first container detection switch 234-1 may be provided between the one end of the first working coil 241 and the second resonance capacitor 233b-1. Upon receiving auxiliary power supplied from the first DC power supply circuit 237-1 in a container detection mode, the first container detection switch 234-1 may be periodically turned on/off to generate a resonance signal.

A first detector 235-1 for detecting the generated resonance signal may be provided between the one end of the first working coil 241 and the second resonance capacitor 233b-1. As in the above example, the first detector 235-1 may include a comparator implemented as an OP Amp, include a comparator and a capacitor, or include a current sensor.

The resonance signal detected by the first detector 235-1 may be input to the controller 300. The controller 300 may detect the container 10 on the first working coil 241 based on the resonance signal detected by the first detector 235-1. Detailed description of the container 10 is the same as the above.

The first DC power supply circuit 237-1, the first container detection switch 234-1, the first resonance capacitor 233b-1, and the first detector 235-1 may constitute a container detection circuit for detecting the container on the first working coil 241.

When the terminals T1/T2 of the first changeover switch 232-1 are connected to the contacts A1/A2, a container detection circuit may be formed. When the container detection circuit is formed, the controller 300 may periodically turn on/off the first container detection switch 234.

When the first container detection switch 234 is periodically turned on/off, resonance is generated by the first working coil 241 and the second resonance capacitor 233b-1, and the first detector 235 may detect a resonance signal. The controller 300 may detect the container 10 on the first working coil 241 based on the detected resonance signal.

When the terminals T1/T2 of the first changeover switch 232-1 are connected to the contact points B1/B2, a heating circuit may be formed. When the heating circuit is formed, the controller 300 alternately turns on/off the first main switch 231a and the second main switch 231b to supply the first working coil 241 with a high-frequency alternating current.

The second changeover switch 232-2 may be disposed between the contact point of the first main switch 231a and the second main switch 231b and a second working coil 242. For example, the second changeover switch 232-2 may be implemented as a double pole double throw relay and may switch connection between two contacts while switching connection between other contacts (between a contact A1 and a contact B1/between a contact A2 and a contact B2).

The second working coil 242 may have one end connected to the second changeover switch 232-2 and the other end connected to a contact point between a pair of resonance capacitors 233a-2 and 233b-2 connected in series. A second DC power supply circuit 237-2 may be connected on a path through which current flows between the contact point and the other end of the second working coil 242.

A second container detection switch 234-2 may be provided between the one end of the second working coil 242 and the second resonance capacitor 233b-2. Upon receiving auxiliary power supplied from the second DC power supply circuit 237-2 in a container detection mode, the second container detection switch 234-2 may be periodically turned on/off to generate a resonance signal.

A second detector 235-2 for detecting the generated resonance signal may be provided between the one end of the second working coil 242 and the second resonance capacitor 233b-2. As in the above example, the second detector 235-2 may include a comparator implemented as an OP Amp, include a comparator and a capacitor, or include a current sensor.

The resonance signal detected by the second detector 235-2 may be input to the controller 300. The controller 300 may detect the container 10 on the second working coil 242 based on the resonance signal detected by the second detector 235-2. Detailed description of the container 10 is the same as the above.

When the terminals T1/T2 of the second changeover switch 232-2 are connected to the contacts B1/B2, a heating circuit may be formed. When the heating circuit is formed, the controller 300 alternately turns on/off the first main switch 231a and the second main switch 231b to supply the second working coil 242 with a high-frequency alternating current.

The first working coil 241 and the second working coil 242 may be independently driven. In particular, the container detection circuit of the first working coil 241 and the container detection circuit of the second working coil 242 may be independently used for respective container detections. That is, container detection on the first working coil 241 and container detection on the second working coil 242 may be simultaneously performed.

Therefore, there is no need to perform a switching operation for alternately applying power from the main power source 20 to the first working coil 241 and the second working coil 242, and the resulting noise may also be prevented.

Hereinafter, a method of controlling an induction heating apparatus according to an embodiment will be described. An object controlled by the method of controlling an induction heating apparatus according to the embodiment is the induction heating apparatus 1 described above. That is, the method of controlling the induction heating apparatus according to the embodiment may be performed by the induction heating apparatus 1 described above.

Therefore, the description of the induction heating apparatus 1 described above may be applied to the embodiment of the method of controlling the induction heating apparatus unless otherwise stated. Conversely, the description of the method of controlling the induction heating apparatus may also be applied to the embodiment of the induction heating apparatus 1.

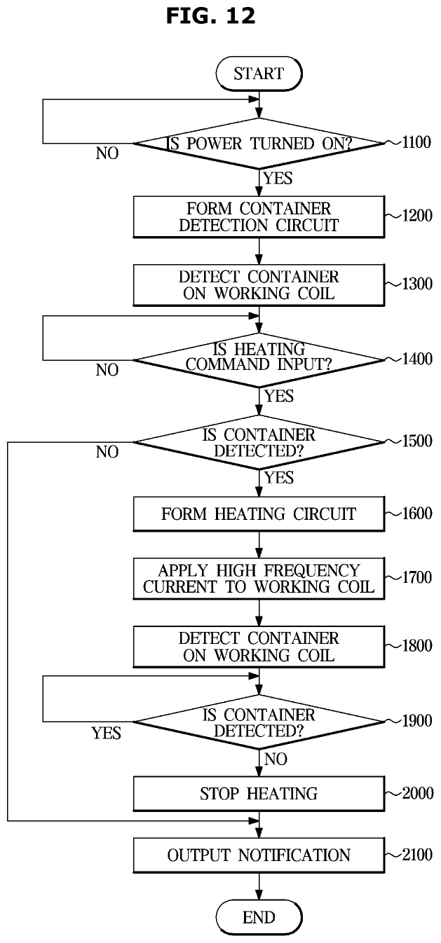

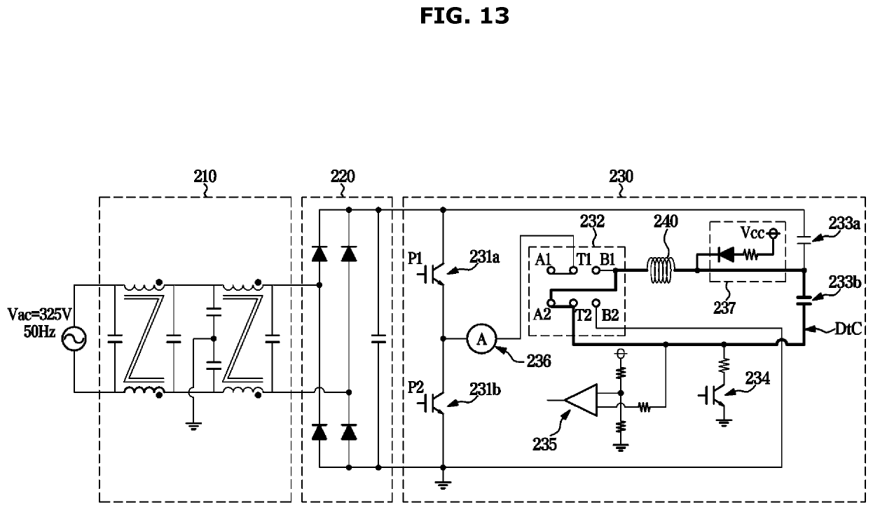

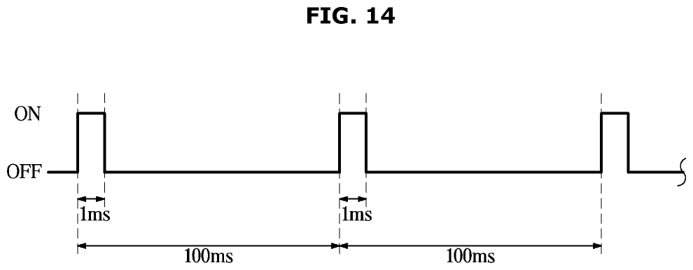

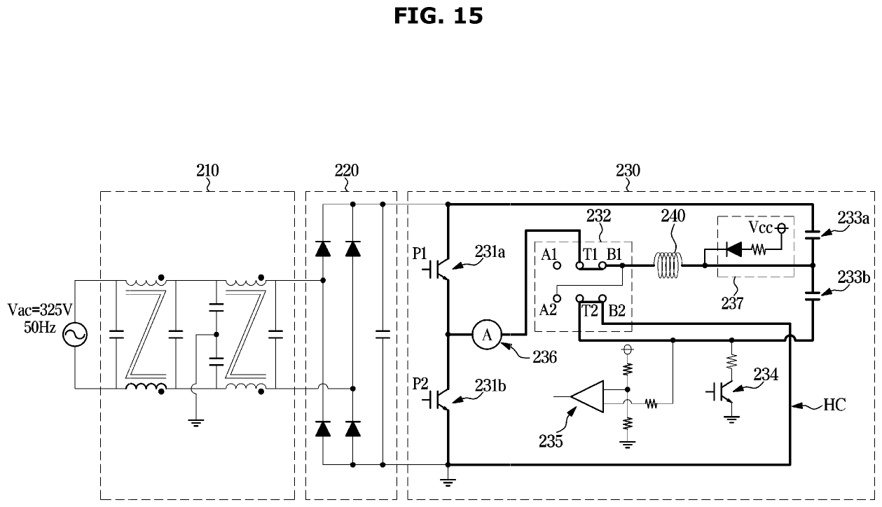

FIG. 12 is a flowchart showing a method of controlling an induction heating apparatus according to an embodiment. FIG. 13 is a diagram illustrating a container detection circuit formed during execution of a method of controlling an induction heating apparatus according to an embodiment. FIG. 14 is a diagram illustrating a signal applied to a container detection switch to detect a container during execution of a method of controlling an induction heating apparatus according to an embodiment. FIG. 15 is a diagram illustrating a heating circuit formed during execution of a method of controlling an induction heating apparatus according to an embodiment.

Referring to FIG. 12, in response to the induction heating apparatus 1 being powered on (YES in operation 1100), the controller 300 may control the coil driver 230 to enter a container detection mode. That is, a container detection circuit may be formed (1200).

Referring to FIG. 13 together with FIG. 12, the controller 300 may control the changeover switch 232 such that the terminals T1/T2 are connected to the contacts A1/A2. By the connection, a container detection circuit (DtC) including a working coil 240, a DC power supply circuit 237, a second resonance capacitor 233b, a container detection switch 234, and a detector 235 may be formed.

The container detection circuit (DtC) is in a state in which electrical connection with the main power supply 20 is cut off. Accordingly, the controller 300 may maintain the first main switch 231a and the second main switch 231b in an off state.

A container 10 on the working coil 240 is detected (1300).

The detecting of the container 10 on the working coil 240 may represent all of a series of operations performed to detect the container 10 on the working coil 240. Specifically, the detecting of the container 10 on the working coil 240 may include controlling, by a controller 300, a container detection switch 234 and identifying whether a container is present on the working coil 240 based on a resonance signal provided from the detector 235.

The container detection circuit may allow a current supplied from the DC power supply circuit 237 to pass therethrough, and the controller 300 may periodically turn on/off the container detection switch 234 to generate resonance.

For example, as shown in FIG. 14, the controller 300 may turn on the container detection switch 234 at intervals of 100 ms. In this case, the time for which the container detection switch 234 maintains the on state may be set to 1 ms.

However, the configuration shown in FIG. 14 is only an example applicable to the induction heating apparatus 1 and the period at which the container detection switch 234 is turned on or the time for which the container detection switch 234 maintains the on state may be set to be different from the example shown in FIG. 14 as long as resonance can be generated by the working coil 240 and the second resonance capacitor 233b.

When the container 10 is not located on the working coil 240, a resonance signal as shown in FIG. 7 may be generated, and when the container 10 is located on the working coil 240, a resonance signal as shown in FIG. 8 may be generated.

The detector 235 may detect the resonance signal and provide the detected resonance signal to the controller 300. Depending on the type of the detector 235, the type of signals provided to the controller 300 may also vary. For example, the resonance signal may be a pulse signal provided to the controller 300. The controller 300 may count the number of pulses or count the duration of a pulse. The controller 300 may compare the counted number of pulses or the counted time with a reference value to identify whether the container 10 is present.

For example, the controller 300 may be configured to, in response to the counted number of pulses or the counted time being less than the reference value, identify that the container 10 is located on the working coil 240. In addition, the controller 300 may be configured to, in response to the counted number of pulses or the counted time being greater than or equal to the reference value, identify that the container 10 is not located on the working coil 240.

In response to a heating command being input through the input device 130 (YES in operation 1400), only while the container 10 on the working coil 240 is detected (YES in operation 1500), the controller 300 may form a heating circuit (1600). That is, even with a heating command being input, the heating mode may be entered only based on the container 10 being present on the working coil 240.

When a plurality of cooking zones are provided in the induction heating apparatus 1, the induction heating apparatus 1 may enter a heating mode only based on the container 10 being present in a cooking zone selected through the input device 130, that is, being present on a working coil 240 corresponding to the selected cooking zone.

Based on a container 10 not being detected on the working coil 240 (NO in operation 1500), a notification for warning the absence of a container 10 may be output (2100).

The notification may be output visually through the display 120 or, if the induction heating apparatus 1 includes a speaker, may be output auditorily through the speaker. Combinations of visual and auditory notifications may be implemented without departing from the scope of the present disclosure.

Meanwhile, the operation 1300 of detecting the container 10 on the working coil 240 may be performed periodically or in real time. The controller 300 may form a heating circuit based on the most recent identification result from the point in time when a heating command is input.

Alternatively, the operation 1300 of detecting the container 10 on the working coil 240 may be performed in response to a heating command being input through the input device 130.

Returning to the operation 1600 of forming the heating circuit, the controller 300 may control the changeover switch 232 to form a heating circuit. Referring to FIG. 15, the controller 300 may connect the terminals T1/T2 of the changeover switch 232 to the contacts B1/B2. By the connection, a heating circuit (HC) electrically connected to the main power supply 20 may be formed.

Referring to FIG. 15, a diode is provided in the DC power supply circuit 237. Therefore, even when a high voltage is applied to the working coil 240 by the main power supply 20, the diode may block reverse current caused by the high voltage, thereby protecting the DC power supply circuit 237.

However, the DC power supply circuit 237 may not need to include a diode, and may use other circuit elements, such as MOSFETs or load switches, to prevent circuit damage due to application of a high voltage in a heating mode.

For the heating operation, the controller 300 may apply a high frequency current to the working coil 240 (1700).

To apply the high frequency current to the working coil 240, the controller 300 may alternately turn on/off the first main switch 231a and the second main switch 231b.

As described above, the amount of heat generated in the container 10 may be determined according to the frequency of the current applied to the working coil 240. The controller 300 may determine the on/off frequencies of the first main switch 231a and the second main switch 231b based on a heating intensity selected through the input device 130.

The controller 300 may alternately turn on/off the first main switch 231a and the second main switch 231b according to the determined on/off frequency, thereby applying, to the working coil 240, a high-frequency current having a frequency corresponding to the selected heating intensity.

The controller 300 may perform detection of the container 10 on the working coil 240 even in the heating mode (1800).

Referring to FIG. 5 described above, the current sensor 236 installed in the current path between the node between the first main switch 231a and the second main switch 231b and the working coil 240 may detect the magnitude of the current flowing current through the working coil 240.

The controller 300 may identify whether the container 10 is located on the working coil 240 based on the output of the current sensor 236. For example, the controller 30 may, in response to the output of the current sensor 236 being lower than a reference value, identify that the container 10 is located on the working coil 240. Conversely, the controller 300 may be configured to, in response to the output of the current sensor 236 being greater than or equal to the reference value, identify that the container 10 is not located on the working coil 240.

Based on a container 10 not being detected (NO in operation 1900), the controller 300 may stop heating (2000) and output a notification (2100). Accordingly, a high-frequency current may be prevented from being applied to the working coil 240 in a state in which a container 10 is not present, and the stability of the induction heating apparatus 1 may be improved.

Detection of the container 10 may be performed periodically or in real time. The controller 300 may, based on a container 10 not being detected, the controller 300 may immediately stop heating and output a notification.

Alternatively, the controller 300 may, based on a container 10 not being detected for a reference time, stop heating and output a notification. For example, the following description may be made in relation to a case in which the reference time is set to ten seconds.

The controller 300 may be configured to, in a heating mode, apply a high frequency current to the working coil 240 while detecting the container 10 of the working coil 240 based on an output of the current sensor 236.

Upon a container 10 not being detected at a certain point in time, the controller 300 may identify whether the state in which the container 10 is not detected is maintained for ten seconds or longer. For example, the output of the current sensor 236 may be compared with a reference value periodically or in real time during a period of ten seconds.

As another example, the controller 300 may compare the output of the current sensor 236 with a reference value based on ten seconds elapsing after the point in time at which the container 10 is not detected, to detect a container 10.

That is, it is not that the container 10 should not be detected at every time point during a predetermined time, but that the container 10 should not be detected when the controller 300 attempts to detect the container 10 again within a predetermined time.

When the state in which the container 10 is not detected is maintained for ten seconds or longer, the controller 300 may turn off the first main switch 231a and the second main switch 231b to stop heating (2000), and output a notification indicating that the container 10 is not detected (2100). The notification may be output visually through the display 120 and/or aurally through a speaker.

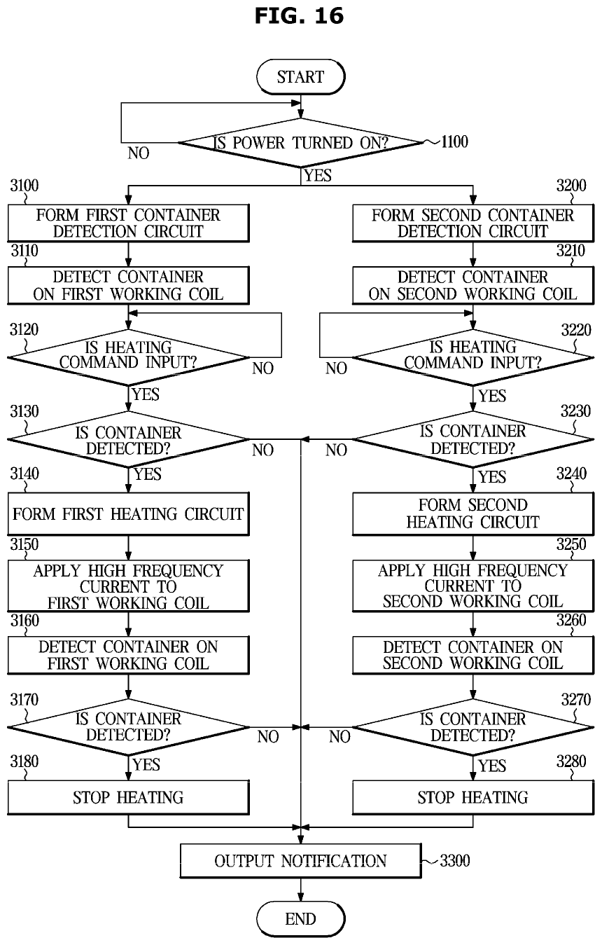

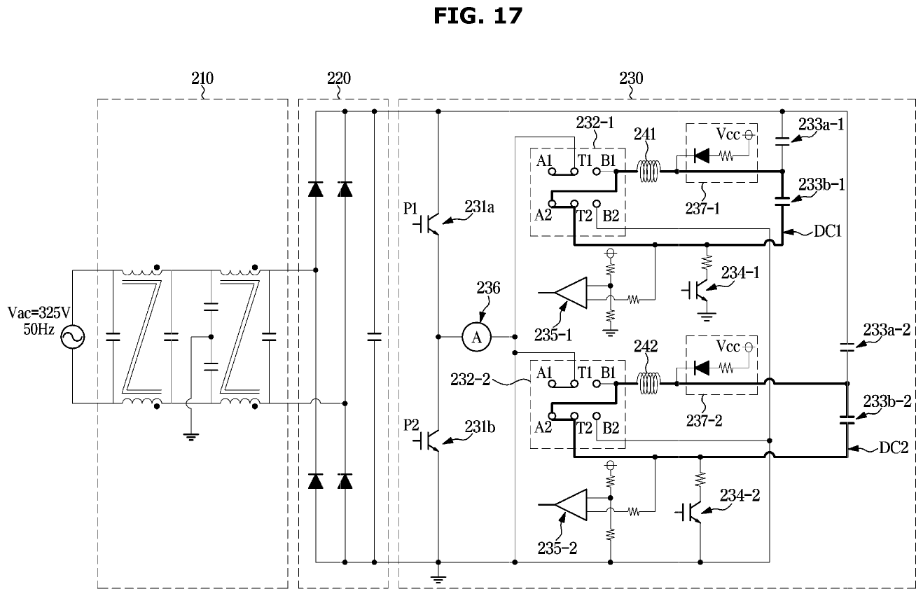

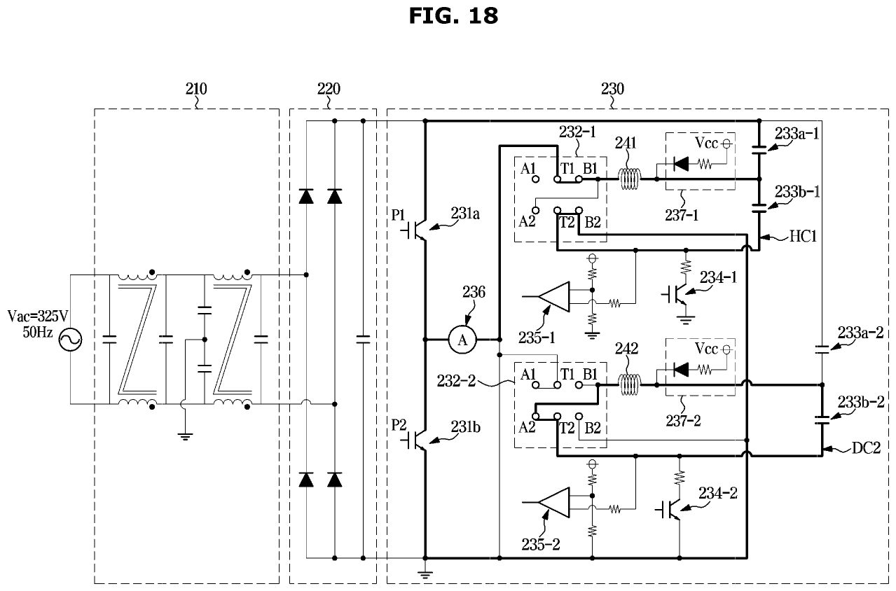

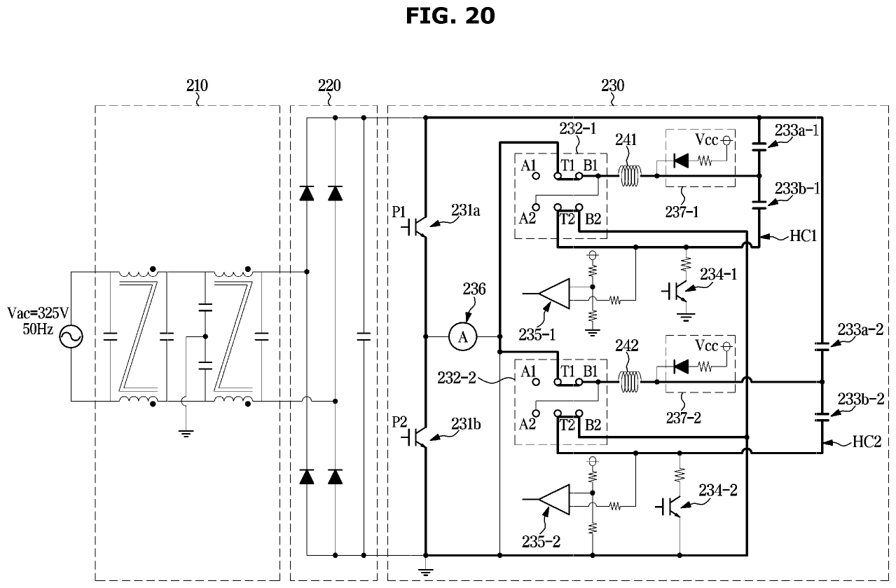

FIG. 16 is a flowchart illustrating a case in which a plurality of working coils are provided, in a method of controlling an induction heating apparatus according to an embodiment. FIG. 17 is a diagram illustrating a container detection circuit formed during execution of a method of controlling an induction heating apparatus according to an embodiment. FIGS. 18, 19, and 20 are diagrams illustrating a heating circuit formed during execution of a method of controlling an induction heating apparatus according to an embodiment.

In the example, for the sake of convenience of description, a case in which two working coils 241, 242 are provided is described, but the description may be equally applied even to a case in which three or more working coils are provided, except that the number of container detection circuits and heating circuits increase to correspond to the number of the working coils.

Referring to FIG. 16, in response to the induction heating apparatus 1 being powered on (YES in operation 3000), the controller 300 may control the coil driver 230 to enter a container detection mode. That is, a first container detection circuit DC1 may be formed (3100), and a second container detection circuit DC2 may be formed (3200).

Referring to FIG. 17, the controller 300 may individually control the first changeover switch 232-1 and the second changeover switch 232-2 such that the terminals T1/T2 are connected to the A1/A2 contacts.

By the connection, the first container detection circuit DC1 including a first working coil 241, a first DC power supply circuit 237-1, a first resonance capacitor 233b-1, a first container detection switch 234-1, and a first detector 235-1 may be formed.

In addition, the second container detection circuit DC2 including a second working coil 242, a second DC power supply circuit 237-2, a second resonance capacitor 233b-2, a second container detection switch 234-2, and a second detector 235-2 may be formed.

The first container detection circuit DC1 and the second container detection circuit DC2 are in a state in which electrical disconnection with the main power supply 20 is cut off. Accordingly, the controller 300 may maintain the first main switch 231a and the second main switch 231b in an off state.

A container 10 on the first working coil 241 is detected (3110), and a container 10 on the second working coil 242 is detected (3210).

A current applied from the first DC power supply circuit 237-1 flows through the first container detection circuit DC1. The controller 300 may periodically turn on/off the first container detection switch 234-1 to generate resonance.

A current applied from the second DC power supply circuit 237-2 flows through the second container detection circuit DC2. The controller 300 may periodically turn on/off the second container detection switch 234-2 to generate resonance.

The first detector 235-1 may detect a resonance signal generated by the first container detection circuit DC1 and provide the detected resonance signal to the controller 300. The second detector 235-2 may detect a resonance signal generated by the second container detection circuit DC2 and provide the detected resonance signal to the controller 300.

While a heating command for a cooking zone corresponding to the first working coil 241 is input (YES in operation 3120), only in response to a container 10 on the first working coil 241 being detected (YES in operation 3130), the controller 300 may form a first heating circuit (3140).

While a heating command for a cooking zone corresponding to the second working coil 242 is input (YES in operation 3220), only in response to a container 10 on the first working coil 241 being detected (YES in operation 3230), the controller 300 may form a second heating circuit (3140).

The detecting of the container 10 and the forming of the heating circuit may be performed independently on each working coil. Therefore, only in response to the first working coil 241 satisfying a heating circuit formation condition, the controller 300 may control only the first changeover switch 232-1 for the terminals T1/T2 to be connected to the contacts B1/B2 as shown in FIG. 17. The second changeover switch 232-2 may be kept with the terminals T1/T2 connected to the contacts A1/A2.

Here, the heating circuit formation condition may include a heating command input for a corresponding working coil and a presence of the container 10 on the corresponding working coil. Therefore, the controller 300 may form a first heating circuit HC1 only when the container 10 is present on the first working coil 241 and a heating command for the first working coil 241 is input.

Conversely, in response to only the second working coil 242 satisfying a heating circuit formation condition, the controller 300 may control only the second changeover switch 232-2 for the terminal T1/T2 to be connected to the contacts B1/B2 to form a second heating circuit HC2 as shown in FIG. 18. The first changeover switch 232-1 may be kept with the terminals T1/T2 connected to the contacts A1/A2.

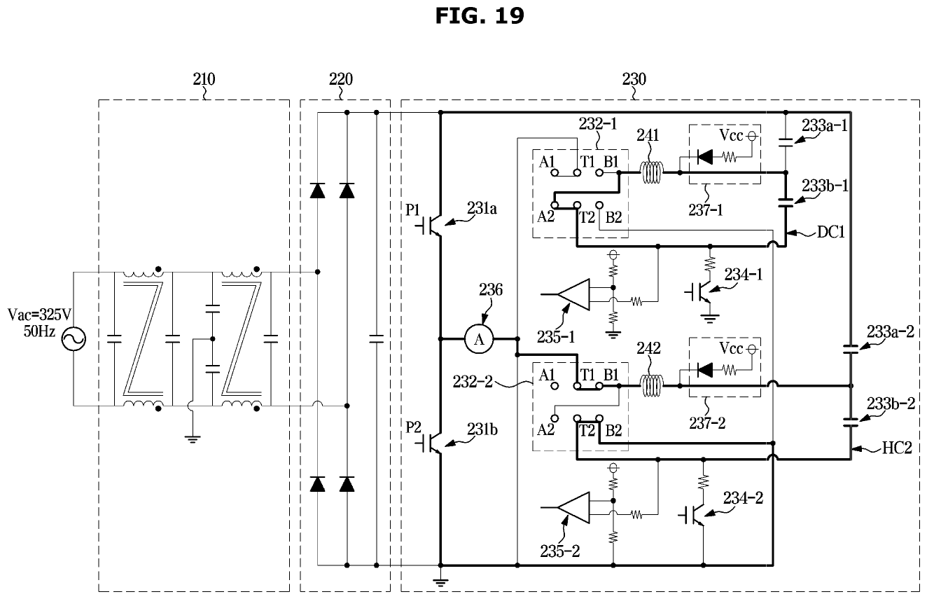

Alternatively, in response to both the first working coil 241 and the second working coil 242 satisfying the heating circuit formation condition, the controller 300 may control both the first changeover switch 232-1 and the second changeover switch 232-2 for the terminals T1/T2 to be connected to the contacts B1/B2 as shown in FIG. 19.

As another example, while a container 10 is placed on only one of the first working coil 241 and the second working coil 242, the container 10 may, only upon a selection of the heating intensity being input even without selection of a cooking zone, form a heating circuit for applying a high-frequency current to the working coil on which the container 10 is placed.

In response to the first heating circuit HC1 being formed, the controller 300 may apply a high-frequency current to the first working coil 241 (3150) and perform container detection on the first working coil 241 (3160).

The controller 300 may determine on/off frequencies of the first main switch 231a and the second main switch 231b based on the heating intensity selected through the input device 130.

The controller 300 may alternately turn on/off the first main switch 231a and the second main switch 231b according to the determined on/off frequency, so that a high-frequency current having a frequency corresponding to the selected heating intensity may be applied to the first working coil 241.

In the heating mode, the controller 300 may identify whether the container 10 is located on the first working coil 241 based on the output of the current sensor 236. For example, the controller 300 may be configured to, in response to the output of the current sensor 236 being lower than a reference value, identify that the container 10 is located on the first working coil 241. Conversely, the controller 300 may be configured to, in response to the output of the current sensor 236 being greater than or equal to the reference value, identify that the container 10 is not located on the first working coil 241.

In response to a container 10 on the first working coil 241 not being detected (NO in operation 3170), the controller 300 may stop heating (3180) and output a notification (3300).

The controller 300 may immediately stop heating and output a notification after a container 10 is not detected on the first working coil 241, or may stop heating and output a notification based on a predetermined time elapsing after a container 10 is not detected on the first working coil 241. The notification may be output visually through the display 120 and/or aurally through a speaker.

In response to the second heating circuit HC2 being formed, the controller 300 may apply a high-frequency current to the second working coil 242 (3250), and may perform container detection on the second working coil 242 (3260).

The controller 300 may identify on/off frequencies of the first main switch 231a and the second main switch 231b based on the heating intensity selected through the input device 130.

The controller 300 may alternately turn on/off the first main switch 231a and the second main switch 231b according to the determined on/off frequency, so that a high frequency current of a frequency corresponding to the selected heating intensity may be applied to the second working coil 242.

In the heating mode, the controller 300 may identify whether the container 10 is located on the second working coil 242 based on the output of the current sensor 236. For example, the controller 300 may be configured to, in response to the output of the current sensor 236 being lower than a reference value, identify that the container 10 is located on the second working coil 242. Conversely, the controller 300 may be configured to, in response to the output of the current sensor 236 being greater than or equal to the reference value, identify that the container 10 is not located on the second working coil 242.

In response to a container 10 on the second working coil 242 not being detected (NO in operation 3270), the controller 300 may stop heating (3280) and output a notification (3300).

The controller 300 may immediately stop heating and output a notification after a container 10 on the second working coil 242 is not detected, or may stop heating and output a notification based on a predetermined time elapsing after a container 10 on the second working coil 242 is not detected. The notification may be output visually through the display 120 and/or aurally through a speaker.

On the other hand, when the container 10 is placed on the first working coil 241 and the second working coil 242 at the same time, the controller 300 may detect the container 10 based on the phase difference between the voltage and current output from the current sensor 236.

For example, in response to the container 10 placed on at least one of the first working coil 241 and the second working coil 242 being moved while both the first working coil 241 and the second working coil 242 are operating in the heating mode, the inductance value of the corresponding coil abruptly increases, which causes a phase delay.

The controller 300 may, in response to such a phase delay occurring, control the first changeover switch 232-1 and the second changeover switch 232-2 for the first working coil 241 and the second working coil 242 to be alternately connected to the current sensor 236.

When the first working coil 241 is connected to the current sensor 236, the controller 300 may detect whether a container on the first working coil 241 is present based on the output of the current sensor 236, and when the second working coil 242 is connected to the current sensor 236, the controller 300 may detect whether a container on the second working coil 242 is present based on the output of the current sensor 236.

Alternatively, the controller 300 may control the first changeover switch 232-1 and the second changeover switch 232-2 to form a first container detection circuit DC1 and a second container detection circuit DC2, and detect the presence or absence of a container on the first working coil 241 and the second working coil 242 based on the outputs of the first detector 235-1 and the second detector 235-2.

The method of controlling the induction heating apparatus described above may be stored in a recording medium in which instructions executable by a computer are stored. That is, instructions for performing the method of controlling the induction heating apparatus may be stored in a recording medium.

The instructions may be stored in the form of program code and, when executed by a processor, may perform the operations of the disclosed embodiments.

The recording medium may be embodied as a computer-readable recording medium. Here, the recording medium is a non-transitory computer-readable medium that stores data non-temporarily.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

Although embodiments of the present disclosure have been described for illustrative purposes, those skilled in the art will appreciate that various modifications, additions and substitutions are possible, without departing from the scope and spirit of the disclosure. Therefore, embodiments of the present disclosure have not been described for limiting purposes.

What is claimed is:

1. An induction heating apparatus comprising:
a working coil;
a coil driver configured to supply the working coil with main power for heating; and
at least one processor configured to control the coil driver,
wherein the coil driver includes:
a direct current (DC) power supply circuit configured to supply the working coil with auxiliary power for container detection;
a resonance capacitor connected to the working coil; and
a container detection switch connected to the working coil, configured to be turned on and off;
wherein the at least one processor is configured to, while the coil driver operates as a container detection circuit for detecting a container on the working coil, identify whether a container is present on the working coil based on a resonance signal generated by on/off operation of the container detection switch.

2. The induction heating apparatus of claim 1, wherein the coil driver further includes a changeover switch configured to convert the coil driver to operate as one of the container detection circuit and a heating circuit configured to heat the container on the working coil.

3. The induction heating apparatus of claim 2, wherein the at least one processor is configured to, in order to operate the coil driver as the container detection circuit, control the changeover switch such that one end of the working coil is connected to the container detection switch.

4. The induction heating apparatus of claim 2, wherein the at least one processor is configured to, in order to operate the coil driver as the heating circuit, control the changeover switch such that one end of the working coil is connected to a main power supply circuit.

5. The induction heating apparatus of claim 2, wherein the coil driver includes a first main switch and a second main switch, and
the at least one processor is configured to:
while the coil driver operates as the container detection circuit, turn off both the first main switch and the second main switch; and
while the coil driver operates as the heating circuit, alternately turn on/off each of the first main switch and the second main switch.

6. The induction heating apparatus of claim 2, further comprising a current sensor configured to detect a current flowing in the working coil,
wherein the at least one processor is configured to, while the coil driver operates as the heating circuit, identify whether a container is present on the working coil based on an output of the current sensor.

7. The induction heating apparatus of claim 2, wherein the coil driver further includes a detector configured to detect a resonance signal generated by periodic on/off operation of the container detection switch, and
wherein the at least one processor is configured to identify whether a container is present on the working coil based on an output of the detector.

8. The induction heating apparatus of claim 7, wherein the detector includes a comparator configured to output a voltage pulse corresponding to the resonance signal, and
wherein the at least one processor is configured to determine whether a container is present on the working coil based on the output voltage pulse.

9. The induction heating apparatus of claim 7, wherein the detector includes a current sensor configured to output a current corresponding to the resonance signal, and
wherein the at least one processor is configured to identify whether a container is present on the working coil based on the detected current.

10. The induction heating apparatus of claim 2, wherein the at least one processor is configured to:
in response to the induction heating apparatus being powered on, control the changeover switch to operate the coil driver as the container detection circuit; and
in response to a heating command being input while the container is located on the working coil, control the changeover switch to operate the coil driver as the heating circuit.

11. The induction heating apparatus of claim 2, wherein one end of the resonance capacitor is connected to one end of the working coil, and
another end of the resonance capacitor is connected to the one end of the working coil or grounded by the changeover switch.

12. The induction heating apparatus of claim 2, wherein the working coil comprises a plurality of working coils, and
the coil driver comprises a plurality of coil drivers provided to correspond to the plurality of working coils, respectively.

13. The induction heating apparatus of claim 12, wherein the at least one processor is configured to:
based on a resonance signal generated by on/off operation of a container detection switch included in each of the plurality of coil drivers, independently identify whether a container is present on the plurality of working coils.

14. A method of controlling an induction heating apparatus including a working coil and a coil driver configured to supply the working coil with main power for heating, the method comprising:
in response to the induction heating apparatus being powered on, converting the coil driver to operate as a container detection circuit;
identifying whether a container is present on the working coil using the container detection circuit; and
in response to a heating command being input while the container is located on the working coil, converting the coil driver to operate as a heating circuit.

15. The method of claim 14, wherein the coil driver includes:
a direct current power supply circuit configured to supply the working coil with auxiliary power for container detection;
a resonance capacitor connected to the working coil; and
a container detection switch connected to the working coil, configured to be turned on and off.

16. The method of claim 14, further comprising, monitoring the presence of the container on the working coil, and maintain operation as a heating circuit while the container is detected.

17. The method of claim 14, further comprising, in response to detecting the container is not located on the working coil, stopping heating by the working coil.

18. The method of claim 14, further comprising, in response to detecting the container is not located on the working coil, generating an output notification.
